(19) United States
(12) Patent Application Publication
(10) Pub. No.: US 2025/0383902 A1
(43) Pub. Date: Dec. 18, 2025

(54) SERIALIZATION SYSTEM USING OPERATING SYSTEM SPECIFIC PARAMETERS

(71) Applicant: International Business Machines Corporation, Armonk, NY (US)

(72) Inventors: Lisa Cranton Heller, Rhinebeck, NY (US); Nadia Salahuddin, Jackson Heights, NY (US)

(21) Appl. No.: 18/743,182

(22) Filed: Jun. 14, 2024

(51) Int. Cl. G06F 9/455; G06F 9/448

(52) U.S. Cl. CPC G06F 9/45558; G06F 9/448; G06F 2009/45587

(57) ABSTRACT

Computer-implemented methods for a serialization system using operating system specific parameters are disclosed herein. Aspects include a hypervisor executing on a host server dispatching a virtual machine. Aspects also include transmitting an indication of an active operating system (OS) of the virtual machine to the host server. Aspects further include modifying a default attempt limit using an OS-specific attempt limit associated with the active OS in response to determining that the active OS of the virtual machine is associated with an OS-specific parameter.

### BACKGROUND

The present invention generally relates to memory management in the operating system kernel, and more specifically, to computer systems, computer-implemented methods, and computer program products for a serialization system for multiprocessor systems.

In a mixed operating system runtime environment in which a multiprocessor system executes logical partitions that are associated with different operating systems (OS), processes can access shared hardware resources. Shared resources are accessible to processors of the system, where each processor accesses the resource in a coherent way. The system can utilize process serialization where different threads agree upon the sequence in which the access to the shared resources occurs. Shared resources are difficult to maintain due to strict consistency requirements. Serialization and other methods to ensure consistency can contribute to problems of computer organization because the need for consistency applies in numerous use cases, from hardware to distributed systems, and can cause a negative impact on performance and function.

### SUMMARY

Embodiments of the present invention are directed to a computer-implemented method for a serialization system using OS-specific parameters. According to an aspect of the invention, a computer-implemented method includes a hypervisor executing on a host server dispatching a virtual machine. The method also includes transmitting an indication of an active operating system (OS) of the virtual machine to \ the host server. The method further includes, in response to determining that the active OS of the virtual machine is associated with an OS-specific parameter, modifying a default attempt limit using an OS-specific attempt limit associated with the active OS.

In one embodiment of the present invention, the OS-specific attempt limit is stored in millicode of the host server.

In one embodiment of the present invention, the method includes, in response to determining a serialization request is needed, transmitting a logical partition-based serialization request to a serialization state machine. The method further includes, in response to receiving a rejection from the serialization state machine, incrementing an attempt counter. The method also includes determining that the attempt counter exceeds the OS-specific attempt limit. The method includes broadcasting a system-wide serialization request.

In one embodiment of the present invention, the method includes, in response to determining a serialization request is needed, transmitting a logical partition-based serialization request to a serialization state machine. The method further includes updating a shared resource associated with the serialization request. The method also includes resetting the serialization state machine.

In one embodiment of the present invention, the OS-specific attempt limit is greater than the default attempt limit.

In one embodiment of the present invention, the method includes modifying the OS-specific attempt limit based on a number of escalations that occurred within a period of time for a logical partition and a corresponding necessity ranking. The corresponding necessity ranking is determined based on hardware arbiter rejection rates, time elapsed between serialization requests, and utilization of receiver threads.

According to another non-limiting embodiment of the invention, a system having a memory having computer readable instructions and one or more processors for executing the computer readable instructions, the computer readable instructions controlling the one or more processors to perform operations. The operations include a hypervisor executing on a host server dispatching a virtual machine. The operations also include transmitting an indication of an active operating system (OS) of the virtual machine to the host server. The operations further include, in response to determining that the active OS of the virtual machine is associated with an OS-specific, modifying a default attempt limit using an OS-specific attempt limit associated with the active OS.

According to another non-limiting embodiment of the invention, a computer program product for a pipeline query transformation system is provided. The computer program product includes a computer-readable storage medium having program instructions embodied therewith, the program instructions executable by a processor to cause the processor to perform operations. The operations include a hypervisor executing on a host server dispatching a virtual machine. The operations also include transmitting an indication of an active operating system (OS) of the virtual machine to the host server. The operations further include, in response to determining that the active OS of the virtual machine is associated with an OS-specific parameter, modifying a default attempt limit using an OS-specific attempt limit associated with the active OS.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 illustrates a block diagram of a system, according to one or more embodiments of the present invention;

FIG. 3 illustrates a block diagram for a serialization system using OS-specific parameters according to one or more embodiments of the present invention;

FIG. 4 depicts an example quiescing mechanism for a serialization system according to one or more embodiments of the present invention;

FIG. 5 depicts an example data flow of a serialization system using OS-specific parameters according to one or more embodiments of the present invention;

FIG. 6 depicts a flowchart for a method for modifying an OS-specific parameter in a serialization system according to one or more embodiments of the present invention; and

FIG. 7 depicts a flowchart for a method for a serialization system using OS-specific parameters according to one or more embodiments of the present invention.

### DETAILED DESCRIPTION

Disclosed herein are methods, systems, and computer program products for a serialization system that uses operating system (OS)-specific parameters. As discussed above, shared resources in a mixed operating system runtime environment are difficult to maintain due to strict consistency requirements. In some architecture systems, processes must ensure that no other process is currently accessing a shared hardware resource. This involves using a serialization, or quiescing, mechanism to interrupt software threads and having them pause their activities until the initiating process finishes modifying the resource.

During the execution of the quiesce operation, the threads of the system enter a paused state, called a quiesced state. During the quiesce operation, which is a hardware serialization mechanism controlled by trusted firmware, a mandatory internal quiesce interrupt is handled through hardware, which prevents threads from circumventing these interrupts. Accordingly, it is important that the serialization mechanism is as performant and sparingly used as possible.

In some embodiments, the serialization is significantly performance-taxing. For certain operations, initiating threads must update the shared resource in order to make forward progress, and they may have no option but to initiate the serialization request, and thereby interrupt other processes. Accordingly, conflict occurs between the initiating threads and interrupted or receiving threads because both must make forward progress but can only do so through impeding the others

In some embodiments, the amount of time the receiving threads are paused is reduced using a serialization process known as fast-quiesce. They purge the appropriate buffered values that rely on the shared resource and then are allowed to continue execution and are only further paused when they attempt an access which relies on that shared resource. In some embodiments, the scope of the threads that are interrupted is limited. If a shared resource is exclusively accessed by a certain logical partition (i.e., software configuration), then only the threads of any superset of partitions, including the relevant partition, may be interrupted using a serialization process known as logical-partition-based fast-quiesce. However, if the fast-quiesce mechanism is unavailable due to contention in the hardware arbiter engines, then the serialization request must escalate to a conventional quiesce mechanism which interrupts all threads, a system-wide serialization request, to ensure forward progress for the initiating thread.

Under control of trusted firmware, when a serialization request in the fast-quiesce mechanism is rejected, the rejected threads may join in on an existing system-wide serialization request after a certain number of failed attempts at acquiring the hardware arbiter engines. This number is referred to as the threshold value. If no system-wide serialization request is currently in process when a thread is rejected, the trusted firmware may continue issuing requests to the hardware arbiters on behalf of the software thread, which can reject or accept the requests. If rejected, the trusted firmware running on behalf of those threads may then issue its own independent system-wide request after surpassing an even higher number of attempted requests, called the limit value. These two values parametrize the frequency of escalation. The number of times threads issue system-wide serialization requests in order to ensure forward progress for themselves should be minimized. The principle is based on mutual respect for every thread’s forward progress: threads should not escalate until necessary.

The systems and methods described herein can use information about the software (i.e., program type) to alter a hardware state machine. Additionally, the system utilizes the millicode as the interface for modification of the hardware parameters because the other layers of firmware may not have the same level of privilege in that they do not have write access to control registers. Additionally, the system can monitor and utilize program performance metrics to dynamically alter the OS-specific parameters to improve system efficiency and performance.

In some embodiments, values that should be used for the OS-specific parameter are determined by monitoring the performance of operations systems or logical partitions to identify those that are especially active in sending partition-specific serialization requests. OS-specific parameters are generated for the more active OS or logical partitions, such as increasing an attempt limit for the more active OS or logical partitions to reduce the number of system-wide requests originating due to them. The systems and methods described herein modify existing hardware parameters for more active OS or logical partitions using the generated OS-specific parameters. The determination and application of the OS-specific or logical partition-specific parameters occurs in the millicode layer of a hosting server and does not require change in any operating system kernel. In some embodiments, generating the OS-specific parameter also includes consideration of the tolerance of the operating system of the increased limit (i.e., extended time to make forward progress).

In some embodiments, parameters may be identified by monitoring which operating systems are more likely to execute operations which result in partition-specific serialization requests that escalate to system-wide requests. The proposed parameters are then set in millicode, in place of the previously-default parameters, which were software-agnostic. The system is then tasked with a serialization-biased workload. The relevant performance metrics are collected to determine which values of these escalation parameters yielded the greatest performance improvement across the system without having a noticeably negative effect on the performance of the OS using the adjusted parameters.

In some architecture systems with mixed-OS logical partitions, some threads are especially high in utilization for their time slices. Thus, the escalations from logical partition-specific serialization requests to system-wide requests affect those partitions most adversely. The intention of the original experimentation was to alleviate performance degradation for those partitions caused by escalation due to request originators from other logical partitions, such as those associated with a different OS.

The performance benefits are specific to the workload, but the systems and methods described herein for generating and applying serialization parameters may be applied in numerous instances, such as based on workload/program quality instead of just the OS-variety and does not necessarily have to be preset in virtualization millicode, but also in other instances where frequent escalations are observed.

In some embodiments, dynamic algorithms are utilized for deciding the threshold or limit parameters. For example, some counters may be maintained that describe the number of escalations occurring within a certain time-slice for a virtual processor or partition and how justified those escalations are, which can be measured through an indication of necessity rankings. In some embodiments, necessity rankings are calculated, determined, and/or based on hardware arbiter reject rates, time elapsed between requests, the utilization of receiver threads, or the like. These counters would further consolidate the mutual respect principle by taking into consideration the individual needs of each partition as well as the entire system. If these counters and metrics demonstrate the need to alter the threshold/limit tuple, the system may change it upon the mandatory internal timer interrupt.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

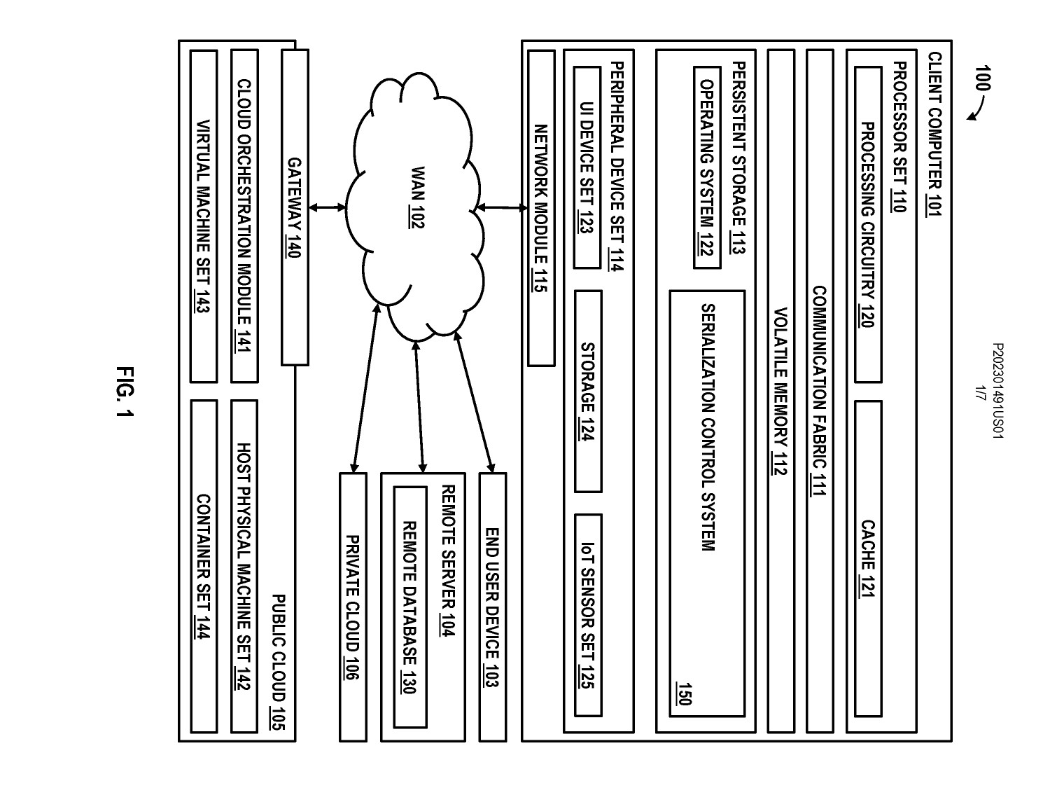

Referring now to FIG. 1, computing environment 100 contains an example of an environment for the execution of at least some of the computer code involved in performing the inventive methods, such as monitoring and tracking performance metrics of virtual machines, generating operating system (OS)-specific or logical partition-specific parameters, applying the OS-specific or logical partition-specific parameters to virtual machines before they are dispatched, and/or dynamically adjusting the OS-specific or logical partition-specific parameters based on performance metrics by a serialization control system 150. In addition to the serialization control system 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the serialization control system 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Client computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing. The processing circuitry includes logic which receives the serialization requests (either fast-quiesce or system-wide), determines if an internal quiesce interruption should be generated for this request, presents the quiesce interruption as needed, and purges any appropriate buffered data associated with the request.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the serialization control system 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths. The communication fabric holds both a fast-quiesce state machine (including a hardware arbiter) and a system-wide serialization engine.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The millicodeincluded in the serialization control system 150 typically includes at least some of the computer code involved in performing the inventive methods. The millicode or trusted firmware resides in persistent storage known as Hardware System Area (HSA) and can only be accessed by trusted firmware.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collects and stores helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

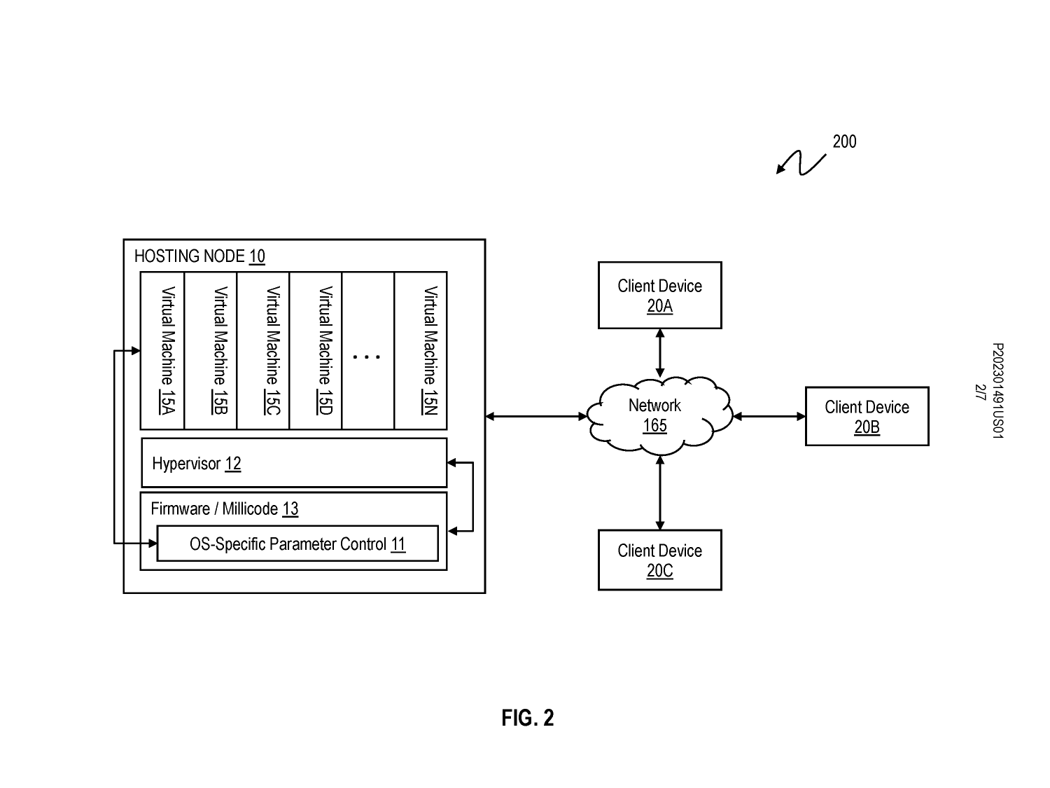

FIG. 2 illustrates an example hosting node 10 according to one or more embodiments of the present invention. The hosting node 10 is in communication with one or more client devices 20A-20C via a network 165. In addition, client devices 20A-20C can have direct communication with hosting node 10. The hosting node 10 can be a datacenter, host server, or a client computer (e.g., client computer 101), of a cloud-computing provider. The hosting node 10 executes a hypervisor 12, which facilitates deploying one or more virtual machines 15 (15A-15N). The hosting node 10 further includes a firmware and/or millicode layer 13 that includes an OS-specific parameter control 11. Millicode is trusted firmware that operates as an extension to the processor hardware. The OS-specific parameter control 11 includes one or more firmware modules and/or millicode that facilitates the hypervisor 12 to provide one or more OS-specific parameters to the virtual machines 15.

The term “virtual machine” or “VM” as used herein refers to a logical representation of a physical machine (computing device, processor, etc.) and its processing environment (operating system (OS), software resources, etc.) The virtual machine state is maintained by the hypervisor that executes on an underlying host machine (physical processor or set of processors). From the perspective of a user or software resource, the virtual machine appears to be its own independent physical machine. The terms “hypervisor” and “VM Monitor (VMM)” as used herein refer to a processing environment or platform service that manages and permits multiple VM's to execute using multiple (and sometimes different) OSs on the same host machine. It should be appreciated that dispatching a VM includes the installation process of the VM and an activation (or starting) process of the VM. In another example, dispatching a VM includes an activation (or starting) process of the VM (e.g., in case the VM is previously installed or already exists).

For example, the hosting node 10 can facilitate a client device 20A to deploy one or more of the virtual machines 15A-15N. The virtual machines 15A-15N may be deployed in response to respective requests from distinct client devices 20A-20C. For example, the virtual machine 15A may be deployed by the client device 20A, the virtual machine 15B may be deployed by the client device 20B, and the virtual machine 15C may be deployed by the client device 20C. The hosting node 10 may also facilitate a client to provision a physical server (without running as a virtual machine). The examples described herein embody the provisioning of resources in the hosting node 10 as part of a ‘virtual machine,’ however, the technical solutions described can be applied to provision the resources as part of a physical server.

In an example, the client devices 20A-20C belong to the same entity, such as a person, a business, a government agency, a department within a company, or any other entity, and the hosting node 10 is operated as a private cloud of the entity. In this case, the hosting node 10 solely hosts virtual machines 15A-15N that are deployed by the client devices 20A-20C that belong to the entity. In another example, the client devices 20A-20C belong to distinct entities. For example, the first entity owns the client device 20A, while a second entity owns the client device 20B. In this case, the hosting node 10 is operated as a public cloud that hosts virtual machines from different entities. For example, the virtual machines 15A-15N are deployed in a shrouded manner in which the virtual machine 15A does not facilitate access to the virtual machine 15B. For example, the hosting node 10 shrouds the virtual machines 15A-15N using an IBM z Systems® Processor Resource/Systems Manager (PR/SM) Logical Partition (LPAR) feature. These features, such as PR/SM LPAR provide isolation between partitions, thus facilitating the hosting node 10 to deploy two or more virtual machines 15A-15N for different entities on the same physical hosting node 10 in different logical partitions.

A client device 20A from the client devices 20A-20C is a communication apparatus such as a computer, a smartphone, a tablet computer, a desktop computer, a laptop computer, a server computer, or any other communication apparatus that requests deployment of a virtual machine by the hypervisor 12 of the hosting node 10. The client device 20A sends a request for receipt by the hypervisor via the network 165 or directly. A virtual machine 15A, from the virtual machines 15A-15N is a virtual machine image that the hypervisor 12 deploys in response to a request from the client device 20A from the client devices 20A-20C. The hypervisor 12 is a virtual machine monitor (VMM), which may be software, firmware, or hardware that creates and runs virtual machines. The hypervisor 12 facilitates the virtual machine 15A to use the hardware components of the hosting node 10 to execute programs and/or store data. With the appropriate features and modifications, the hypervisor 12 can be IBM zSystems®, ORACLE VM SERVER^{TM}, CITRIX XENSERVER^{TM}, VMWARE ESX^{TM}, MICROSOFT HYPER-V^{TM}, or any other hypervisor. The hypervisor 12 can be a native hypervisor executing on the hosting node 10 directly, or a hosted hypervisor executing on another hypervisor.

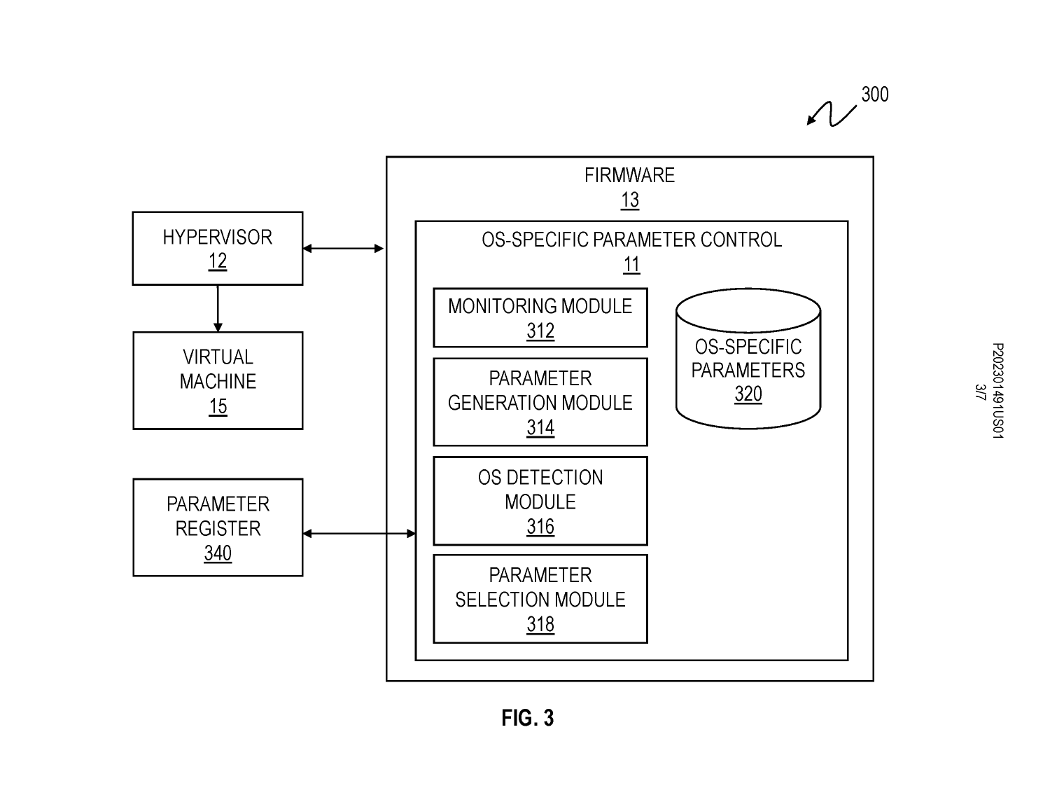

Referring now to FIG. 3, a block diagram for a serialization control system 300 using OS-specific parameters is depicted. In exemplary embodiments, the serialization control system 300 includes an OS-specific parameter control 11 that may be embodied in the firmware 13 of a hosting node 10, such as the one shown in FIG. 2. As illustrated, the OS-specific parameter control 11 can include a monitoring module 312, a parameter generation module 314, an OS detection module 316, a parameter selection module 318, and/or OS-specific parameters 320. The OS-specific parameter control 11 updates the parameter register 340 in the serialization control system 300.

In some embodiments, the monitoring module 312 of the OS-specific parameter control 11 receives and/or otherwise obtains data associated with the performance of virtual machines 15 hosted by a hosting node 10. The monitoring module 312 can monitor and track the performance of the different virtual machines 15. For example, the monitoring module 312 can track an indication of hardware arbiter reject rates. In some embodiments, the monitoring module 312 can maintain trackers for different characteristics of the virtual machines 15, such as the number of escalations occurring during a time-slice or period of time for a virtual processor or partitions. The monitoring module 312 can also track data corresponding to the escalations, such as time elapsed between serialization requests, utilization of receiver threads, and the like. The monitoring module 312 can thus monitor the individual needs of each partition as well as the entire system.

In some embodiments, the parameter generation module 314 of the OS-specific parameter control 11 receives data from the monitoring module 312. The parameter generation module 314 can dynamically generate and/or modify OS-specific parameters, such as OS-specific attempt limits. In some embodiments, the parameter generation module 314 can use machine learning or AI techniques to dynamically generate and/or modify OS-specific parameters based on the data received from the monitoring module 312. The parameter generation module 314 can generate and/or modify the OS-specific parameters on a periodic basis or once a predetermined threshold has been met for one or more of the characteristics tracked by the monitoring module 312. The parameter generation module 314 can store and/or update OS-specific parameters in a datastore, such as the OS-specific parameters 320.

In some embodiments, the hypervisor 12 receives a request to dispatch a virtual machine 15. In some embodiments, the request includes information associated with the virtual machine 15, such as software specifications, a specific OS for the virtual machine 15, and the like. The OS detection module 316 accesses or receives the information from the request and determines the OS associated with the virtual machine 15 to be dispatched. In some embodiments, the OS detection module 316 obtains an identifier or label from the request and determines the OS associated with the identifier or label. The hypervisor 12 dispatches the virtual machine 15 and provides an indication of the active OS to the firmware 13 which is invoked to execute the dispatch. In some embodiments, the hypervisor 12 provides an indication of an attribute of the dispatched virtual machine instead of or with the active OS indication.

In some embodiments, the OS detection module 316 uses the active OS information and determines whether the detected OS is associated with an OS-specific parameter. In some embodiments, the OS detection module 315 uses the indication of the attribute of the dispatched virtual machine to determine whether the detected attribute is associated with an OS-specific parameter. In some embodiments, the parameter selection module 318 determines that the detected OS is not associated with an OS-specific parameter and loads the default parameter value into the parameter register 340. In some embodiments, the parameter selection module 318 determines that the detected OS is associated with an OS-specific parameter and retrieves the OS-specific parameter from the datastore, such as OS-specific parameters 320. The parameter selection module 318 modifies the default parameter of the requested virtual machine 15 using the OS-specific parameter corresponding to the detected OS. The parameter selection module 318 modifies the default parameter using the OS-specific parameter in the trusted firmware and/or millicode layer 13. By modifying the parameter register 340 of the hosting node 10, millicode allows the active operating system to uphold the mutual respect principle without making modifications to the hardware or software of the hosting node 10.

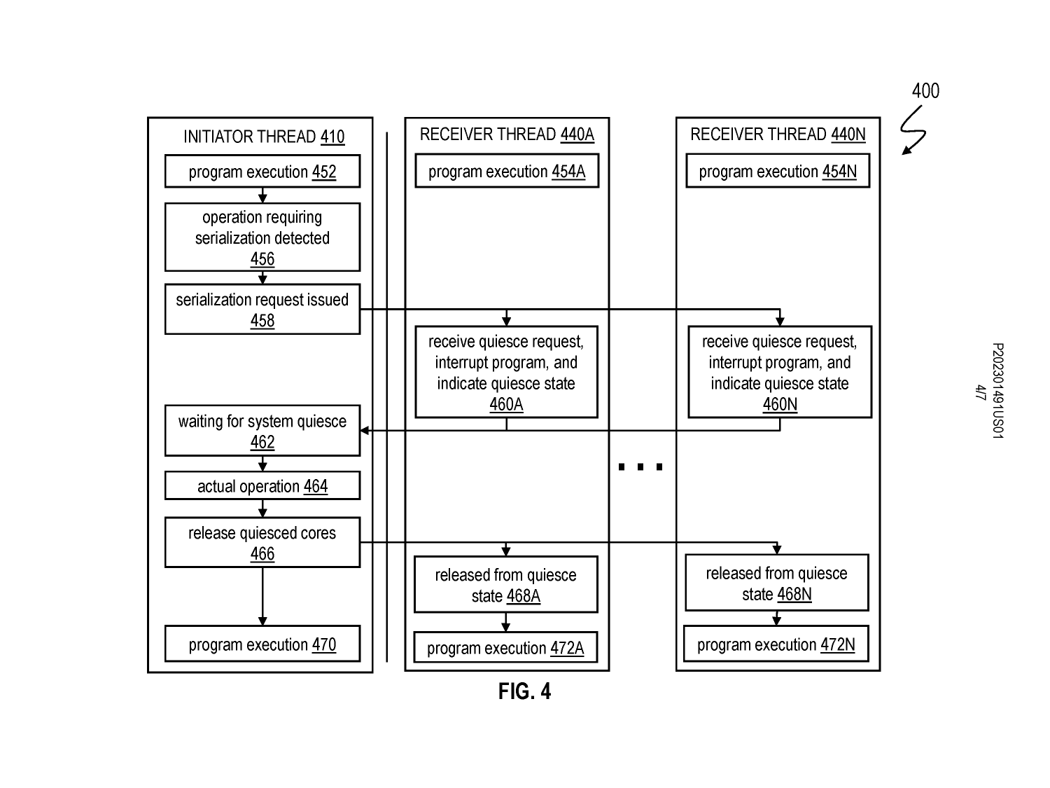

Now referring to FIG. 4, an example quiescing mechanism 400 for a serialization control system 300 according to one or more embodiments of the present invention is depicted. As discussed above, a quiesce operation is responsible for maintaining consistency between the translations-lookaside-buffer (TLBs) in the physical processors of a computing device, such as hosting node 10 and the state of the virtual processors. The quiescing operations are performed by the firmware and/or millicode 13 using hardware provided in both Communication Fabric 111 and Processing Circuitry 120 and happen unbeknownst to and out of the control of the software running on the virtual processor. During the execution of programs, some operations require a processor serialization through a quiescing mechanism. Examples of operations that can initiate a quiesce operation can include but are not limited to an Invalidate Page Table Entry (IPTE) or s Set Storage Key Extended (SSKE).

In some embodiments, there are two types of quiesce operations – fast-quiesce and conventional quiesce. Each of the quiesce operation interruptions cause an internal quiesce interruption to become pending in the applicable cores. As each processor or thread responds to the internal quiesce interruption, the processor invokes millicode or firmware to process the interruption, which causes the software on the interrupted processor to temporarily pause. Fast quiesce requests interrupt only the physical processors currently running in the initiating configuration and/or processors that are associated with the same logical partition as the thread initiating the fast quiesce operation. All the other physical processors can purge their TLBs in the background. Each processor or thread associated with the initiating thread responds to the fast-quiesce interruption at the next interruptible point, purges its TLB, and then continues executing software with hardware preventing or delaying any memory access which might rely on the affected translation table or other system-level resource until the operation that requires it is complete in the system.

Conventional quiesce requests interrupt all physical processors in the system and require that every physical processor respond to the conventional quiesce interruption at the next interruptible point. Each physical processor must remain in the quiesce interruption state until all processors have responded to the quiesce request.

The quiesce operations are accomplished via special commands sent by millicode to the Communication Fabric 111, or “nest” hardware. The nest is responsible for maintaining system-wide storage consistency and for broadcasting commands (e.g., quiesce and purge commands) to processors in the system. With each processor generation, the number of physical processors in the system increases and the relative overhead of nest operations grows. This typically causes both the number of quiesce requests in the system and the overhead of each quiesce operation to increase.

In one example, the initiator thread 410 executes a program at block 452 and the receiver threads (e.g., receiver thread 440A and 440N) execute respective programs at blocks 454A and 454N. During the program execution by the initiator thread 410, an operation requiring a serialization request is detected at block 456. Upon detecting the operation requiring a serialization request, at block 458, the serialization request is issued to the nest at block 458. In some embodiments, the millicode determines which serialization request is required and transmits the serialization request to the nest which then forwards the request to all the processors.

For fast-quiesce requests, the nest maintains multiple serialization state machines that can be referred to as fast-quiesce state machines (fast-QSMs). For example, the nest can maintain one for even-zoned logical partitions and one for odd-zoned logical partitions. The nest checks to see if the specified fast-QSM is busy. If it is not busy, the fast-quiesce request is accepted and the state of fast-QSM is changed to busy. The nest maintains which physical processor initiated the fast-quiesce. The nest then broadcasts the fast-quiesce request in a serialized manner to the other threads in the system and they can be referred to as receiver threads, such as receiver thread 440A through 440N, collectively 440. At blocks 460A to 460N, the receiver threads 440A to 440N execute their respective programs until they receive the fast-quiesce request from the nest. In some embodiments, the processors of the respective receiver threads 440A to 440N determine whether their respective programs need to be interrupted. In response to determining that the program needs to be interrupted, the relevant receiver threads 440A to 440N interrupt the execution of their respective programs and respond to the fast-quiesce request initiated by the initiator thread 410 by indicating its respective quiesce state.

The nest tracks which processors have handled or responded to the requests and notifies the initiator thread 410 at block 462 when all other threads have responded to the request. All receiver threads 440A to 440N, or in some embodiments only those threads associated with the logical partition of the initiator thread 410, respond to the internal fast-quiesce interruption at the next interruptible point, purge their TLB, and then continue executing software with hardware preventing or delaying any memory access which might rely on the affected translation table or other system-level resource, until operation is complete in the system. All the relevant receiver threads 440A to 440N wait for the fast-quiesce completion if and when they try to access memory (e.g., TLB miss) with an address that might be affected by the operation (e.g., TLB purge).

At block 464, the initiator thread 410 completes the actual operation that initiated the quiescing mechanism, such as updating translation table. Upon completion of the operation, at block 466, the nest then resets the fast-QSM per a reset-command from the initiator thread 410 and releases the quiesced cores of the receiver threads 440A through 440N. At blocks 468A to 468N, the receiver threads are released from the quiesce state and can resume their program executions in block 472A to 472B. At block 470, the initiator thread 410 resumes program execution.

If an initiator thread 410 issues a fast-quiesce request when the fast-QSM is already busy with another request, the nest will indicate to the requesting processor that the fast-quiesce request was “rejected.” The initiator thread 410 will then nullify the quiescing instruction (e.g., IPTE), and issue it again. If there are lots of fast-quiesce requests in the system, it may be difficult for the initiator thread 410 to make forward progress. To mitigate this, a conventional quiesce mechanism is provided by the hardware. In the event that an initiator thread 410 is unable to make forward progress due to repeated rejected attempts, the fast-quiesce request may be escalated to a conventional quiesce.

In some embodiments, the nest maintains a conventional-quiesce state machine (conventional-QSM). The conventional-QSM maintains an initiator vector (i.e., one bit per processor). The nest broadcasts conventional quiesce requests to all of the processors or threads in the system and monitors responses from each processor or thread. When all threads have responded, the nest communicates the system-is-quiesced state to each initiator thread 410 and receiver thread 440A through 440N and provides one-at-a-time priority between the initiating processors. The receiving processors must remain in the internal quiesce interruption handler (i.e., paused) until system-is-quiesced. The nest resets the corresponding bit in the conventional-QSM (and eventually the entire conventional-QSM state) after receiving a reset request from each initiator thread 410.

Due to the additional overhead experienced by the conventional-quiesce receivers (i.e., all the other processors or threads in the system) – both due to all processors needing to respond after reaching an interruptible point and to each processor needing to remain in the internal quiesce interrupt handler longer – there is a balance between how many fast-quiesce rejects should cause a conventional quiesce request.

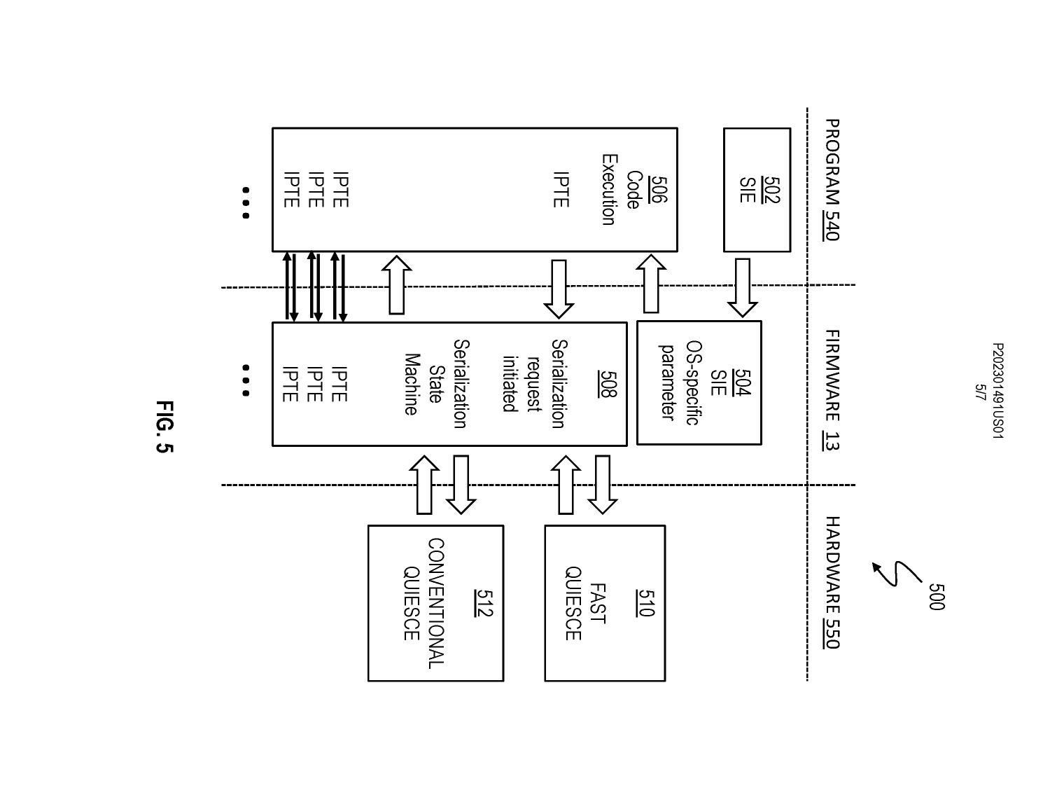

Now referring to FIG. 5, an example data flow 500 of a serialization control system 300 using OS-specific parameters according to one or more embodiments of the present invention is depicted. FIG. 5 depicts the flow of data between the different layers of a computing device utilizing the serialization control system 300. For example, at block 502, the program 540 issues a Start-Interpretive-Execution (SIE) instruction to dispatch a virtual machine 15. The SIE instruction causes the SIE entry millicode to be invoked at block 504.

At block 504, the firmware 13 receives an indication of an active OS for the dispatched virtual machine 15. In response to determining that the active OS associated with the requested virtual machine 15 is associated with an OS-specific parameter, the OS-specific parameter control 11 replaces and/or modifies the default parameter in the parameter register 340 for the virtual machine 15, such as the default attempt limit for processor serialization, using an OS-specific parameter associated with the identified active OS. The OS-specific parameter, such as the OS-specific attempt limit, can be stored in the millicode or hardware 550 of the host node 10. The millicode then loads the guest state of the virtual machine 15 into the hardware 550 during the SIE Entry.

At block 506, when execution of SIE Entry is complete, the control is given to the virtual machine 15 which executes code. During execution of the virtual machine code, if an operation, such as an IPTE, requiring processor serialization is detected, the data flow proceeds to block 508, where a serialization request is initiated in the firmware 13. As discussed in FIG. 4, the firmware 13 initiates a fast-quiesce request which checks the serialization state machine, such as a fast-QSM. If the fast-QSM is not busy and accepts the request, a fast quiesce operation is executed at block 510 in the hardware 550 and an attempt counter tracking the number of attempts rejected by the fast-QSM is reset. The shared resource associated with the serialization request is updated and the fast-QSM is reset. If the fast-QSM is busy and rejects the request, the serialization request is nullified and issued again and an attempt counter is incremented.

At block 508, the attempt counter tracking the number of request attempts rejected by the fast-QSM is compared to the OS-specific parameter from block 504. If the counter exceeds the OS-specific parameter, then the serialization request is escalated to block 512, where a conventional quiesce operation is executed in the hardware 550 and an attempt counter is reset. Upon completion of either the fast or conventional quiesce operation, the data flows back through block 508 to block 506 until another operation requiring serialization is detected and the data flow between block 506 to block 510 or 512 is repeated.

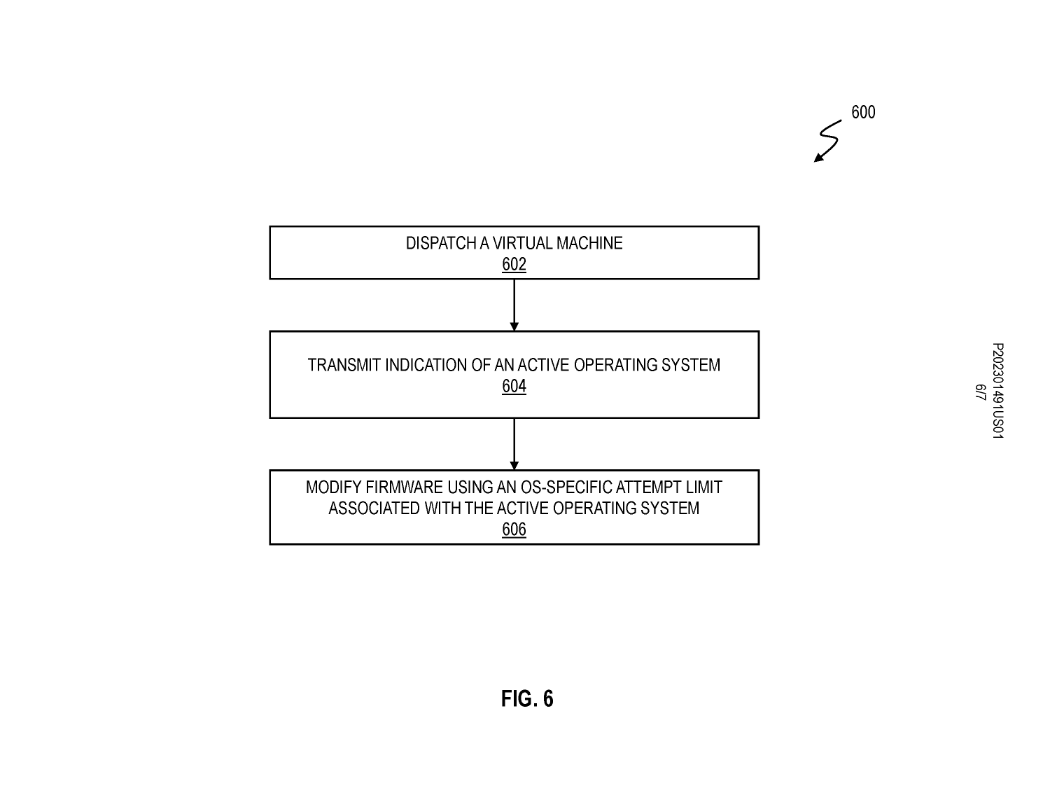

Now referring to FIG. 6, a flowchart for a method 600 for modifying an OS-specific parameter in a serialization control system 300 according to one or more embodiments of the present invention is depicted. The method begins at block 602, by dispatching a virtual machine 15. In some embodiments, a hypervisor 12 of a hosting node 10 dispatches a virtual machine 15 based on a dispatch queue.

Next at block 604, an indication of the active OS associated with the virtual machine 15 is transmitted. In some embodiments, the hypervisor transmits the indication of the active OS of the virtual machine 15 to the firmware of hosting node 10. The OS detection module 316 of the OS-specific parameter control 11 obtains and/or receives the indication from the hypervisor and determines the active OS of the virtual machine.

Next at block 606, firmware of the host node 10 is modified using an OS-specific attempt limit associated with the active OS. In some embodiments, the OS detection module 316 determines whether the detected OS of the virtual machine 15 is associated with an OS-specific parameter. If the parameter selection module 318 determines that the detected OS of the virtual machine 15 is not associated with an OS-specific parameter it loads the default parameter value into the parameter register 340 of the virtual machine . If the parameter selection module 318 determines that the detected OS is associated with an OS-specific parameter, the parameter selection module 318 retrieves the OS-specific parameter from the datastore, such as OS-specific parameters 320. For example, the OS-specific parameter can be an OS-specific attempt limit which indicates the number of serialization request attempts the virtual machine 15 can make to a fast-QSM before escalating the serialization request to a conventional serialization request. In some embodiments, the parameter selection module 318 modifies the default parameter value of the requested virtual machine 15 using the OS-specific parameter value for the OS-specific attempt limit corresponding to the detected OS of the virtual machine in the parameter register 340 .

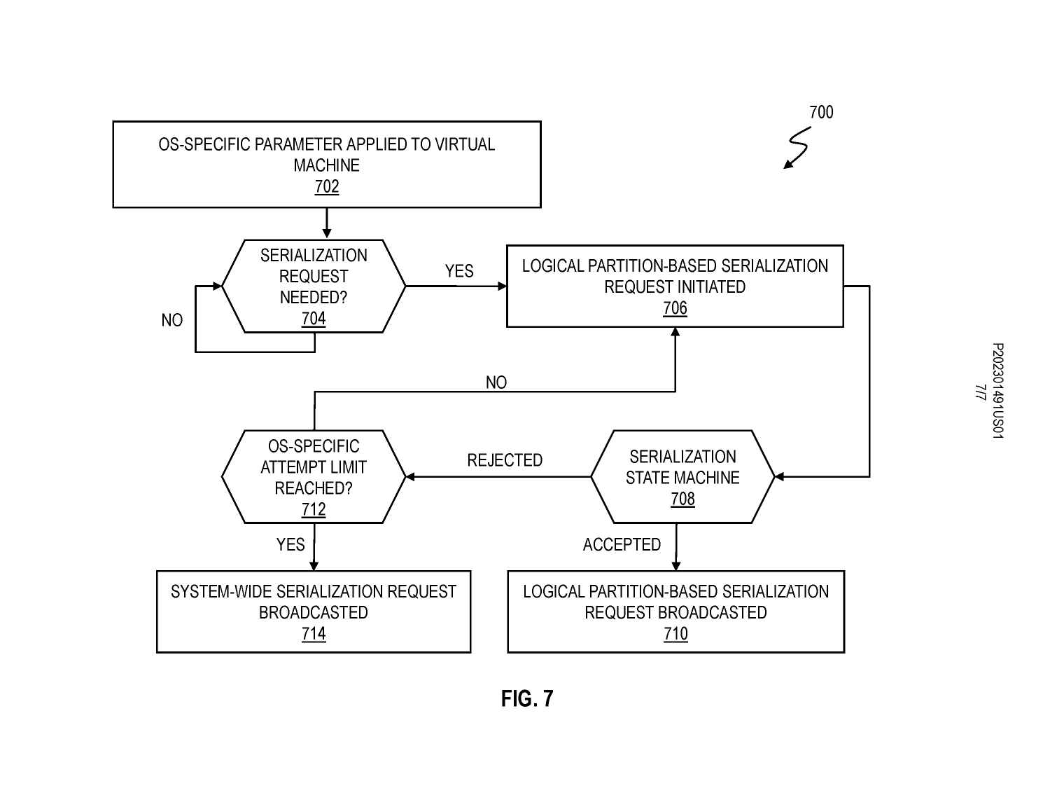

Now referring to FIG. 7, a flowchart for a method 700 for a serialization control system 300 using OS-specific parameters according to one or more embodiments of the present invention is depicted. The method 700 begins at block 702 by applying an OS-specific parameter to the virtual machine 15, as discussed in FIG. 6. After the virtual machine 15 has been dispatched, the method proceeds to block 704, where an initiator thread 410 facilitates program execution. During program execution, if an operation, such as an IPTE, that requires processor serialization is detected, the method proceeds to block 706. If the operation does not require processor serialization, it continues program execution at block 704.

Next at block 706, a logical partition-based serialization request is initiated. In some embodiments, the initiator thread 410 issues the serialization request to the nest, as discussed in FIG. 4. At block 708, the nest checks the serialization state machine, such as the fast-QSM. If the fast-QSM is not busy, the serialization request is accepted and the method proceeds to block 710.

At block 710, the logical partition-based serialization request is broadcasted to the receiver threads 440. In some embodiments, the state of the fast-QSM is changed to busy and the nest broadcasts the fast-quiesce request in a serialized manner to the other receiver threads 440. The nest tracks which processors or threads have responded to the fast-quiesce request and notifies the initiator thread 410 when all other receiver threads 440 have responded to the request. All other receiver threads 440 respond to the fast-quiesce interruption at the next interruptible point, purge their TLBs, and then continue executing software with hardware preventing or delaying any memory access which might rely on the affected translation table or other shared resource until operation is complete in the system. The initiator thread 410 executes the action that initiated the serialization request (e.g., updating a shared resource) and, upon completion of the action, facilitates resetting the fast-QSM and releasing the receiver threads 440 from their respective quiesced states.

If at block 708, the nest determines that the serialization state machine is busy and rejects the serialization request, the method proceeds to block 712. At block 712, in response to the nest determining that the fast-quiesce request was “rejected,” the initiator thread 410 will then nullify the quiescing instruction (e.g., IPTE). In some embodiments, an attempt counter tracking the number of request attempts rejected by the fast-QSM is incremented. The attempt counter is then compared to the OS-specific parameter. If the counter exceeds the OS-specific parameter, then the method proceeds to block 714, where the serialization request is escalated to a system-wide serialization request (e.g., a conventional quiesce operation is executed). Upon completion of the conventional quiesce operation, the method proceeds back to block 704. If at block 712, the attempt counter does not exceed the OS-specific parameter, then the instruction and, when re-executed the serialization request is reissued and the method proceeds back to block 706.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains,” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
dispatching, by a hypervisor executing on a host server, a virtual machine;
transmitting an indication of an active operating system (OS) of the virtual machine to the host server; and
in response to determining that the active OS of the virtual machine is associated with an OS-specific parameter, modifying a default attempt limit using an OS-specific attempt limit associated with the active OS.

2. The computer-implemented method of claim 1, wherein the OS-specific attempt limit is stored in millicode of the host server.

3. The computer-implemented method of claim 1, further comprising:
in response to determining a serialization request is needed, transmitting a logical partition-based serialization request to a serialization state machine;
in response to receiving a rejection from the serialization state machine, incrementing an attempt counter;
determining that the attempt counter exceeds the OS-specific attempt limit; and
broadcasting a system-wide serialization request.

4. The computer-implemented method of claim 1, further comprising:
in response to determining a serialization request is needed, transmitting a logical partition-based serialization request to a serialization state machine;
receiving an acceptance from the serialization state machine;
updating a shared resource associated with the serialization request; and
resetting the serialization state machine.

5. The computer-implemented method of claim 1, wherein the OS-specific attempt limit is greater than the default attempt limit.

6. The computer-implemented method of claim 1, further comprising:
modifying the OS-specific attempt limit based on a number of escalations that occurred within a period of time for a logical partition and a corresponding necessity ranking.

7. The computer-implemented method of claim 6, wherein the corresponding necessity ranking is determined based on hardware arbiter rejection rates, time elapsed between serialization requests, and utilization of receiver threads.

8. A system comprising:
a memory having computer readable instructions; and
one or more processors for executing the computer readable instructions, the computer readable instructions controlling the one or more processors to perform operations comprising:
dispatching, by a hypervisor executing on a host server, a virtual machine;
transmitting an indication of an active operating system (OS) of the virtual machine to the host server; and
in response to determining that the active OS of the virtual machine is associated with an OS-specific parameter, modifying a default attempt limit using an OS-specific attempt limit associated with the active OS.

9. The system of claim 8, wherein the OS-specific attempt limit is stored in millicode of the host server.

10. The system of claim 8, wherein the operations further comprise:
in response to determining a serialization request is needed, transmitting a logical partition-based serialization request to a serialization state machine;
in response to receiving a rejection from the serialization state machine, incrementing an attempt counter;
determining that the attempt counter exceeds the OS-specific attempt limit; and
broadcasting a system-wide serialization request.

11. The system of claim 8, wherein the operations further comprise:
in response to determining a serialization request is needed, transmitting a logical partition-based serialization request to a serialization state machine;
updating a shared resource associated with the serialization request; and
resetting the serialization state machine.

12. The system of claim 8, wherein the OS-specific attempt limit is greater than the default attempt limit.

13. The system of claim 8, wherein the operations further comprise:
modifying the OS-specific attempt limit based on a number of escalations that occurred within a period of time for a logical partition and corresponding necessity ranking.

14. The system of claim 13, wherein the corresponding necessity ranking is determined based on hardware arbiter rejection rates, time elapsed between serialization requests, and utilization of receiver threads.

15. A computer program product comprising a computer readable storage medium having program instructions embodied therewith, the program instructions executable by a processor to cause the processor to perform operations comprising:
dispatching, by a hypervisor executing on a host server, a virtual machine;
transmitting an indication of an active operating system (OS) of the virtual machine to the host server;
in response to determining that the active OS of the virtual machine is associated with an OS-specific parameter, modifying a default attempt limit using an OS-specific attempt limit associated with the active OS.

16. The computer program product of claim 15, wherein the OS-specific attempt limit is stored in millicode of the host server.

17. The computer program product of claim 15, wherein the operations further comprise:
in response to determining a serialization request is needed, transmitting a logical partition-based serialization request to a serialization state machine;
in response to receiving a rejection from the serialization state machine, incrementing an attempt counter;
determining that the attempt counter exceeds the OS-specific attempt limit; and
broadcasting a system-wide serialization request.

18. The computer program product of claim 15, wherein the operations further comprise:
in response to determining a serialization request is needed, transmitting a logical partition-based serialization request to a serialization state machine;
updating a shared resource associated with the serialization request; and
resetting the serialization state machine.

19. The computer program product of claim 15, wherein the OS-specific attempt limit is greater than the default attempt limit.

20. The computer program product of claim 15, wherein the operations further comprise:
modifying the OS-specific attempt limit based on a number of escalations that occurred within a period of time for a logical partition and corresponding necessity ranking.
